(19) United States
(12) Patent Application Publication
(10) Pub. No.: US 2013/0300750 A1
(43) Pub. Date: Nov. 14, 2013

(54) METHOD, APPARATUS AND COMPUTER PROGRAM PRODUCT FOR GENERATING ANIMATED IMAGES

(71) Applicants: Pranav Mishra, Bangalore (IN); Skanda Kumar K N, Bangalore (IN)

(72) Inventors: Pranav Mishra, Bangalore (IN); Skanda Kumar K N, Bangalore (IN)

(73) Assignee: NOKIA CORPORATION, Espoo (FI)

(21) Appl. No.: 13/886,819

(22) Filed: May 3, 2013

(30) Foreign Application Priority Data
May 10, 2012 (IN) 1846/CHE/2012

(51) Int. Cl. G06T 13/00

(52) U.S. Cl. CPC G06T 13/00
USPC 345/474

(57) ABSTRACT

In accordance with an example embodiment a method, apparatus and computer program product are provided. The method comprises facilitating a selection of a region in a multimedia frame and performing an alignment of multimedia frames occurring periodically at a pre-defined interval in a capture order associated with a plurality of multimedia frames based on the multimedia frame comprising the selected region. The method further comprises computing region-match parameters corresponding to the selected region for the aligned multimedia frames. One or more multimedia frames are selected from among the aligned multimedia frames based on the computed region-match parameters and a multimedia frame is identified from among the selected one or more multimedia frames and multimedia frames neighbouring the one or more selected multimedia frames based on the computed region-match parameters. The multimedia frame is identified for configuring a loop sequence for an animated image.

### TECHNICAL FIELD

Various implementations relate generally to method, apparatus, and computer program product for generation of animated images from multimedia content.

### BACKGROUND

Various techniques have been developed for manipulation and processing of multimedia content for generating animated images that may be utilized in a wide variety of applications. An animated image is a short seamlessly looping sequence of graphics interchange format (GIF) images created from video content in which only parts of the image perform minor and repeated movement. An animated image, also referred to as a cinemagraph, captures the dynamics of one particular region in an image for dramatic effect, and provides control over what part of a moment to capture. The animated image enables capturing the dynamics of a moment, for example a waving of a flag or two people shaking hands, in a manner a still image or a video content may not capture.

### SUMMARY OF SOME EMBODIMENTS

Various aspects of example embodiments are set out in the claims.

In a first aspect, there is provided a method comprising: facilitating a selection of a region in a multimedia frame from among a plurality of multimedia frames; performing an alignment of multimedia frames occurring periodically at a pre-defined interval in a capture order associated with the plurality of multimedia frames, wherein the alignment is performed based on the multimedia frame comprising the selected region; computing region-match parameters for the aligned multimedia frames, wherein the region-match parameters are computed corresponding to the selected region in the multimedia frame; selecting one or more multimedia frames from among the aligned multimedia frames based on the computed region-match parameters; and identifying a multimedia frame from among the selected one or more multimedia frames and multimedia frames neighbouring the one or more selected multimedia frames based on the computed region-match parameters, wherein the multimedia frame is identified for configuring a loop sequence for an animated image.

In a second aspect, there is provided an apparatus comprising at least one processor; and at least one memory comprising computer program code, the at least one memory and the computer program code configured to, with the at least one processor, cause the apparatus to at least perform: facilitate a selection of a region in a multimedia frame from among a plurality of multimedia frames; perform an alignment of multimedia frames occurring periodically at a pre-defined interval in a capture order associated with the plurality of multimedia frames, wherein the alignment is performed based on the multimedia frame comprising the selected region; compute region-match parameters for the aligned multimedia frames, wherein the region-match parameters are computed corresponding to the selected region in the multimedia frame; select one or more multimedia frames from among the aligned multimedia frames based on the computed region-match parameters; and identify a multimedia frame from among the selected one or more multimedia frames and multimedia frames neighbouring the one or more selected multimedia frames based on the computed region-match parameters, wherein the multimedia frame is identified for configuring a loop sequence for an animated image.

In a third aspect, there is provided a computer program product comprising at least one computer-readable storage medium, the computer-readable storage medium comprising a set of instructions, which, when executed by one or more processors, cause an apparatus to at least perform: facilitate a selection of a region in a multimedia frame from among a plurality of multimedia frames; perform an alignment of multimedia frames occurring periodically at a pre-defined interval in a capture order associated with the plurality of multimedia frames, wherein the alignment is performed based on the multimedia frame comprising the selected region; compute region-match parameters for the aligned multimedia frames, wherein the region-match parameters are computed corresponding to the selected region in the multimedia frame; select one or more multimedia frames from among the aligned multimedia frames based on the computed region-match parameters; and identify a multimedia frame from among the selected one or more multimedia frames and multimedia frames neighbouring the one or more selected multimedia frames based on the computed region-match parameters, wherein the multimedia frame is identified for configuring a loop sequence for an animated image.

In a fourth aspect, there is provided an apparatus comprising: means for facilitating a selection of a region in a multimedia frame from among a plurality of multimedia frames; means for performing an alignment of multimedia frames occurring periodically at a pre-defined interval in a capture order associated with the plurality of multimedia frames, wherein the alignment is performed based on the multimedia frame comprising the selected region; means for computing region-match parameters for the aligned multimedia frames, wherein the region-match parameters are computed corresponding to the selected region in the multimedia frame; means for selecting one or more multimedia frames from among the aligned multimedia frames based on the computed region-match parameters; and means for identifying a multimedia frame from among the selected one or more multimedia frames and multimedia frames neighbouring the one or more selected multimedia frames based on the computed region-match parameters, wherein the multimedia frame is identified for configuring a loop sequence for an animated image.

In a fifth aspect, there is provided a computer program comprising program instructions which when executed by an apparatus, cause the apparatus to: facilitate a selection of a region in a multimedia frame from among a plurality of multimedia frames; perform an alignment of multimedia frames occurring periodically at a pre-defined interval in a capture order associated with the plurality of multimedia frames, wherein the alignment is performed based on the multimedia frame comprising the selected region; compute region-match parameters for the aligned multimedia frames, wherein the region-match parameters are computed corresponding to the selected region in the multimedia frame; select one or more multimedia frames from among the aligned multimedia frames based on the computed region-match parameters; and identify a multimedia frame from among the selected one or more multimedia frames and multimedia frames neighbouring the one or more selected multimedia frames based on the computed region-match parameters, wherein the multimedia frame is identified for configuring a loop sequence for an animated image.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for generating an animated image in accordance with an example embodiment;

FIG. 3 illustrates a user interface (UI) depicting a motion map generated for indicating motion in a multimedia frame for facilitating selection of a region in the multimedia frame in accordance with an example embodiment;

FIG. 4 illustrates a logical sequence for identifying a multimedia frame for configuring a loop sequence for an animated image in accordance with an example embodiment;

FIG. 5 illustrates a UI depicting a provisioning of multiple loop sequence options based on the selected region in the multimedia frame in accordance with an example embodiment;

FIG. 6 illustrates an animated image in accordance with an example embodiment;

FIG. 7 is a flowchart depicting an example method for generating an animated image in accordance with an example embodiment; and

FIGS. 8A and 8B illustrate a flowchart depicting an example method for generating an animated image in accordance with another example embodiment.

### DETAILED DESCRIPTION

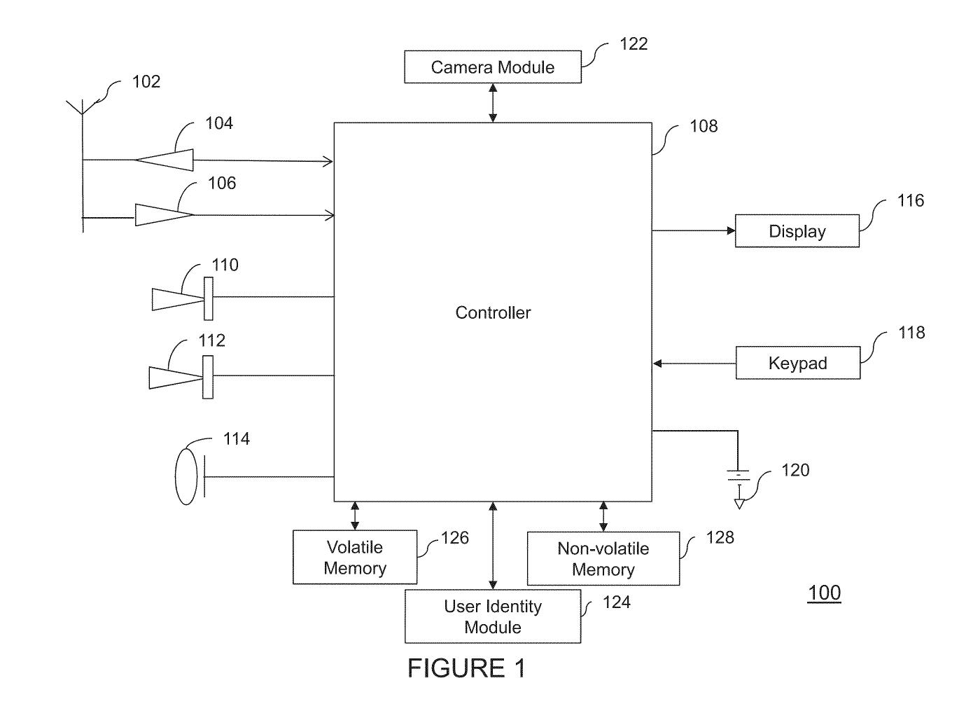

Example embodiments and their potential effects are understood by referring to FIGS. 1 through 8B of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment, the media capturing element is a camera module 122 which may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. In an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

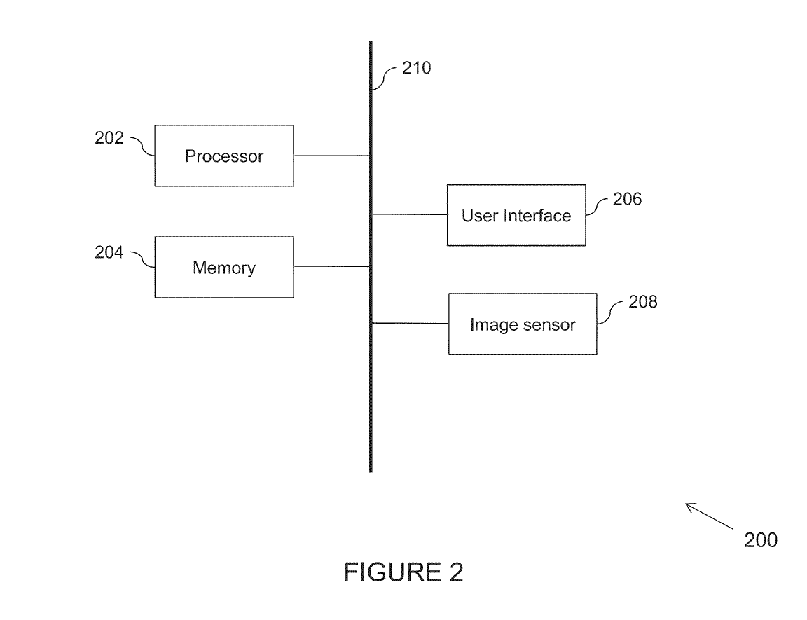

FIG. 2 illustrates an apparatus 200 for generating an animated image in accordance with an example embodiment. The apparatus 200 for generating the animated image may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices). Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory include, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising multimedia content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive multimedia content. Examples of multimedia content may include audio content, video content, data, and a combination thereof.

In an example embodiment, the communication device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

The components 202-208 may communicate with each other via a centralized circuit system 210 to perform generation of the animated image. The centralized circuit system 210 may be various devices configured to, among other things, provide or enable communication between the components 202-208 of the apparatus 200. In certain embodiments, the centralized circuit system 210 may be a central printed circuit board (PCB) such as a motherboard, main board, system board, or logic board. The centralized circuit system 210 may also, or alternatively, include other printed circuit assemblies (PCAs) or communication channel media.

In an example embodiment, the processor 202 is caused to, with the content of the memory 204, and optionally with other components described herein, to cause the apparatus 200 to generate an animated image from the multimedia content. In an embodiment, the multimedia content may be pre-recorded and stored in the apparatus 200. In another embodiment, the multimedia content may be captured by utilizing the camera module 122 of the device 100, and stored in the memory of the device 100. In yet another embodiment, the device 100 may receive the multimedia content from internal memory such as hard drive, random access memory (RAM) of the apparatus 200, or from external storage medium such as DVD, Compact Disk (CD), flash drive, memory card, or from external storage locations through Internet, Bluetooth®, and the like. The apparatus 200 may also receive the multimedia content from the memory 204.

In an embodiment, the multimedia content may comprise a plurality of multimedia frames. In an embodiment, the plurality of multimedia frames comprises a sequence of video frames. The sequence of video frames may correspond to a single scene of the multimedia content. In an embodiment, the plurality of multimedia frames may correspond to video content captured by the image sensor 208 and stored in the memory 204. It is noted that the terms ‘multimedia frames’ and ‘frames’ are used interchangeably herein and refer to the same entity.

In an example embodiment, the processor 202 is caused to, with the content of the memory 204, and optionally with other components described herein, to cause the apparatus 200 to facilitate a selection of a region in a multimedia frame from among a plurality of multimedia frames. In an embodiment, the selection of the region comprises selection of at least one of an object (for example, a person, an entity or an article) and a portion (for example, an area or a section) in a multimedia frame for imparting movement in an animation image to be generated from the plurality of multimedia frames. For example, the plurality of multimedia frames may depict a scene where a news reporter is presenting a commentary in breezy environmental conditions. One or more multimedia frames may depict a blowing of a hair portion of the news reporter while presenting the commentary. An object in the multimedia frame, for example the news reporter, or a region in the multimedia frame, for example an area in the multimedia frame depicting blowing of the hair portion may be selected for imparting repeated movement in the animated image. In an embodiment, the selection of the region in the multimedia region may be facilitated for rendering the object/portion stationary with non-selected regions imparted with movement in the animated image. In an embodiment, the selection of the region is performed based on a user input. In an embodiment, the user input is facilitated by one of a mouse click, a touch screen command, and a user gaze. In an embodiment, the selection of the region is performed without input from the user. For example, the region may be automatically selected based various pre-defined criteria. For example, the selection of the region can be performed based on a keyword. For example, if a user wants to select a region depicting a car, the user may provide input as keyword ‘car’ and the region depicting car may be selected, for example, by performing object detection. In an example embodiment, the user interface 206 may be configured to receive the keywords as input.

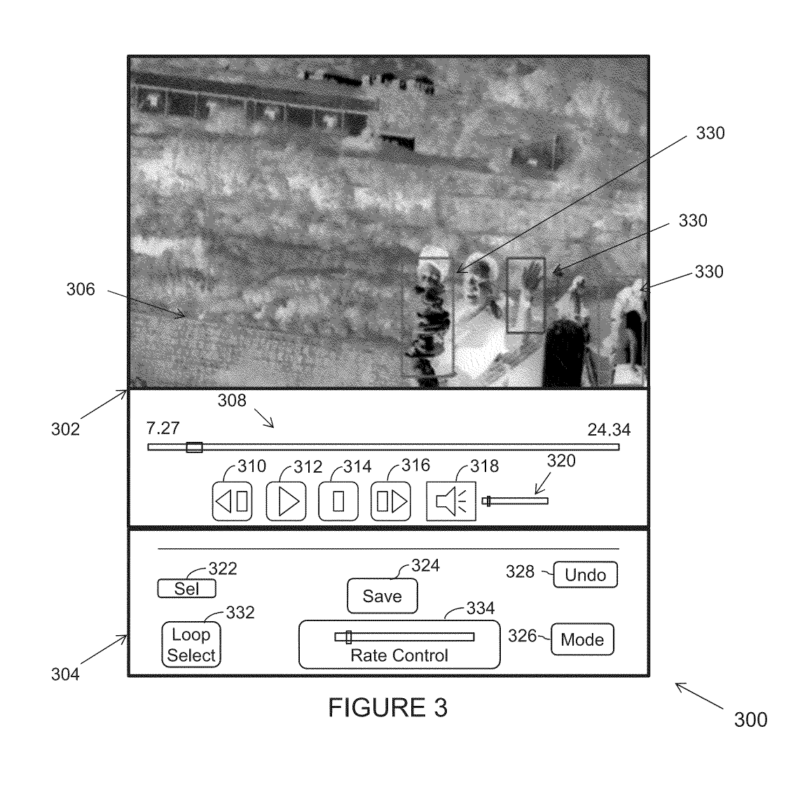

In an embodiment, the user may provide the selection of the region in the multimedia frame for imparting movement in the animated image using the user interface 206. In an embodiment, the selected portion may appear highlighted on the user interface 206. The user interface 206 for displaying the plurality of objects, the selected and deselected objects on the user interface 206, and various options for facilitating the selection of the region are described in detail in FIG. 3. In an example embodiment, a processing means may be configured to facilitate the selection of a region in a multimedia frame from among a plurality of multimedia frames. An example of the processing means may include the processor 202, which may be an example of the controller 108.

In an example embodiment, the processor 202 is caused to, with the content of the memory 204, and optionally with other components described herein, to cause the apparatus 200 to generate motion map for indicating motion in one or more multimedia frames for facilitating selection of the region in the multimedia frame. In an example embodiment, a motion map is a visual representation associated with multimedia frames, where one or more areas associated with motion (hereinafter referred to as motion areas) are identified and highlighted, for example by bounding boxes such as a rectangle. In an embodiment, a user may not be aware of multiple motion areas in a scene that he/she has captured. The motion map provides a visual clue for motion areas in a multimedia frame to make selection of region for configuration of the animated image intuitive. For example, the plurality of multimedia frames may depict a scene where a child is flying a kite in an outdoor environment. One or more multimedia frames may depict a swaying of the kite in the wind with corresponding hand movements of the child. An object in the multimedia frame, for example the kite, and/or a region in the multimedia frame, for example a region encompassing the hand movements of the child in the multimedia frame may be enveloped within a bounding box for indicating motion in a multimedia frame. Providing such a motion map may facilitate a selection of the region in the multimedia frame. In an example embodiment, multiple motion areas in a multimedia frame may be highlighted by different coloured boxes. In an example embodiment, the user may select the region by clicking inside the bounding box.

In an example embodiment, the processor 202 is caused to, with the content of the memory 204, and optionally with other components described herein, to cause the apparatus 200 to perform a background subtraction (or removal) of multimedia frames. The background subtraction of multimedia frames may involve subtracting multimedia frame from an average frame computed from a plurality of multimedia frames to extract foreground regions in a binary image format. These foreground regions may correspond to motion area(s). In an embodiment, all the binary images corresponding to the foreground regions may be aggregated into one image to represent the motion map for motion areas in the multimedia frame sequence. In an example embodiment, a morphological filtering may be performed to remove noise present in the aggregated image. In an example embodiment, a connected component labelling may be performed to differentiate the motion maps of different regions. A size filtering may be performed to allow display of only dominant motion maps while suppressing the insignificant/smaller motion maps. Bounding boxes with best fit around the motion maps may thereafter be displayed. In an example embodiment, multiple motion maps (for example, bounding boxes) may be displayed for facilitating a selection of the region.

In an example embodiment, the motion areas may be estimated based on one of image frequency analysis and block-matching algorithms. In an embodiment, detection of motion in the plurality of multimedia frames is performed by analyzing an optical flow pattern. The optical flow pattern may refer to a pattern of apparent motion of objects, surfaces, and edges in a scene. Upon computing the optical flow pattern, motion areas may be determined by analyzing a flow field, for example, by utilizing thresholding techniques. In an example embodiment, a processing means may be configured to generate motion map for indicating motion in one or more multimedia frames for facilitating selection of the region in the multimedia frame. An example of the processing means may include the processor 202, which may be an example of the controller 108.

In an example embodiment, the processor 202 is caused to, with the content of the memory 204, and optionally with other components described herein, to cause the apparatus 200 to facilitate receiving a user input for performing one of an addition and deletion of region associated with the generated motion map for selecting the region in the multimedia frame. For example, in some cases, the motion map may not capture regions associated with motion in the multimedia frames with desired accuracy and the motion areas may exceed the region encompassed by a bounding box corresponding to the motion map or the bounding box may be too large for an associated motion area. In an example embodiment, the addition or the deletion of the region associated with the generated motion map may be facilitated through a segmented view of the region. In an embodiment, similar pixels in a multimedia frame are grouped into one super pixel to configure segments and the user can fine tune by either deselecting the already selected segments or by selecting new ones, thereby performing the requisite addition/deletion of the region associated with the generated motion map. For example, user might be interested only in movement of a hair portion as opposed to an entire face portion. In such a scenario, finer selection is possible by allowing the user to select accurate region boundary (by selecting/deselecting segments) within bigger bounding box. In an embodiment, desired selection may be achieved based on object detection, for example, face detection. In an embodiment, the user may provide input as ‘face’. If a user wants to select a specific face, keywords for example, name of the person and ‘face’ may be provided as input. Accordingly, face identification may be performed to select the region. In an example embodiment, the user interface 206 is configured to receive the keywords as input. In an example embodiment, a processing means may be configured to facilitate receiving a user input for performing one of an addition and deletion of region associated with the generated motion map for selecting the region in the multimedia frame. An example of the processing means may include the processor 202, which may be an example of the controller 108.

In an example embodiment, the processor 202 is caused to, with the content of the memory 204, and optionally with other components described herein, to cause the apparatus 200 to perform an alignment of multimedia frames occurring periodically at a pre-defined interval in a capture order associated with the plurality of multimedia frames. In an embodiment, the capture order associated with the plurality of multimedia frames may refer to an order in which multimedia frames corresponding to a scene are captured, for example, by a media-capture device such as image sensor 208.

In an embodiment, subsequent to receiving a selection of the region in a multimedia frame, a region closest to the selected region in a subsequent multimedia frame may be identified for configuring a loop sequence from the multimedia frame with the selected region to the multimedia frame including a region substantially matching the selected region. Accordingly, multimedia frames occurring periodically at a pre-defined interval in a capture order associated with the plurality of multimedia frames may first be aligned. In an embodiment, the alignment is performed based on the multimedia frame comprising the selected region. For example, if the multimedia frames in an order of capture are numbered from 1 to N and if the user selects a region in multimedia frame number 4 and if the pre-defined interval corresponds to an interval of five multimedia frames, then multimedia frame numbers 9, 14, 19, 24 (for example, multimedia frames occurring periodically in the capture order) and so on and so forth may be aligned with respect to the multimedia frame number 4 (for example, frame including the selected region).

The alignment of the multimedia frames may involve aligning similar content across the multimedia frames and removing jitter introduced either on account of movement of media capture medium (e.g., from being handheld) or on account of transient environmental conditions, such as high wind conditions, during the capture of the multimedia content. Two-dimensional (2D) and three-dimensional (3D) multimedia stabilization algorithms may be employed for performing the alignment. In an embodiment, the 2D algorithms may estimate camera motion in the 2D image plane motion and zoom or crop to compensate. The motion may be evaluated in a variety of ways, including optical flow, stable feature points, and block-based cross-correlation. In an embodiment, 3D video stabilization algorithms may identify stable 3D feature points by structure-from-motion and apply image based or warping techniques to cope with parallax effect. In an example embodiment, a processing means may be configured to perform an alignment of multimedia frames occurring periodically at a pre-defined interval in a capture order associated with the plurality of multimedia frames, where the alignment is performed based on the multimedia frame comprising the selected region. An example of the processing means may include the processor 202, which may be an example of the controller 108.

In an example embodiment, the processor 202 is caused to, with the content of the memory 204, and optionally with other components described herein, to cause the apparatus 200 to compute region-match parameters for the aligned multimedia frames. The region-match parameters are computed corresponding to the selected region in the multimedia frame. A region-match parameter is configured to provide an indication of a degree of match between the selected region in the multimedia frame and a similar region in an aligned multimedia frame. In an example embodiment, the region-match parameters are sum of absolute differences (SAD) values. In an example embodiment, SAD value for regions in the aligned multimedia frames corresponding to the selected region in the multimedia frame are computed. In an example embodiment, a lower SAD value may correspond to a higher degree of match between corresponding regions in an aligned multimedia frame and the multimedia frame with the selected region. In an example embodiment, a processing means may be configured to compute region-match parameters for the aligned multimedia frames. An example of the processing means may include the processor 202, which may be an example of the controller 108.

In an example embodiment, the processor 202 is caused to, with the content of the memory 204, and optionally with other components described herein, to cause the apparatus 200 to select one or more multimedia frames from among the aligned multimedia frames based on the computed region-match parameters. As explained above, the region-match parameter is indicative of a degree of match between the selected region in the multimedia frame and similar regions in aligned multimedia frames. Based on region-match parameter, aligned multimedia frames with the closest match to the selected region may be selected. For example, if multimedia frame numbers 6, 11, 16, 21 . . . N, are aligned with respect to multimedia frame number 1, and SAD values corresponding to regions similar to the selected region are computed and compared, then the aligned multimedia frames corresponding to the region-match parameter with best match characteristics (low SAD values) may be selected. In an example embodiment, an upper limit on a number of multimedia frames to be selected may be defined. For example, 10% of the aligned multimedia frames with lowest SAD values may be selected for loop sequence consideration. For example, if 300 multimedia frames are aligned, then 30 multimedia frames (10%) with low SAD values may be selected from the aligned multimedia frames. It is noted that a smaller or a higher percentage of multimedia frames with lowest SAD values may be selected from among the aligned multimedia frames. In an example embodiment, a processing means may be configured to select one or more multimedia frames from among the aligned multimedia frames based on the computed region-match parameters. An example of the processing means may include the processor 202, which may be an example of the controller 108.

In an example embodiment, the processor 202 is caused to, with the content of the memory 204, and optionally with other components described herein, to cause the apparatus 200 to identify a multimedia frame from among the selected multimedia frames and multimedia frames neighbouring the selected multimedia frames based on the computed region-match parameters. For example, if multimedia frame numbers 6, 15, 26 . . . M in the capture order associated with the plurality of multimedia frames are selected based on the region-match parameters, then a multimedia frame is identified from among these selected multimedia frames and multimedia frames neighbouring the selected multimedia frames, such as multimedia frames neighbouring multimedia frame number 6; multimedia frames neighbouring multimedia frame number 15 and the like. In an example embodiment, the multimedia frame is identified for configuring a loop sequence for an animated image.

In an example embodiment, identifying the multimedia frame includes performing for the selected multimedia frames: reducing the pre-defined interval by a fractional value and determining a multimedia frame occurring at the reduced pre-defined interval from the selected multimedia frame in an ascending capture order and a descending capture order associated with the plurality of multimedia frames. In an example embodiment, the fractional value may be ½ and the pre-defined interval may be reduced to ½ its value. It should be noted that the fractional value of ½ is provided for exemplary purposes and the fractional value may be any such fractional value configured to be lesser or greater than ½. For example, if the pre-defined interval of 8 frames was chosen for performing alignment of multimedia frames, then pre-defined interval may be reduced to ½×8=4 frames, and accordingly multimedia frames at the reduced pre-defined interval (for example, interval of 4 frames) may be determined in ascending capture order and descending capture order for the selected multimedia frames. It is noted that the capture order of multimedia frames may refer to an order of capture of multimedia frames corresponding to a scene and if the frames are numbered according to capture order from frame number 1 to N, then the ascending capture order may refer to an increasing order of frame capture, such as frame numbers 1, 2, 3 . . . N and a descending capture order may refer to a decreasing order of frame capture, such as frame numbers N, N−1, N−2 . . . 3, 2 and 1. For example, if frame number 8 in the capture order is the selected multimedia frame and the reduced pre-defined interval is 4, then frame number 4 in the ascending capture order and frame number 12 in the descending capture order may be determined.

In an example embodiment, identifying the multimedia frame further includes performing for the selected one or more multimedia frames: computing the region-match parameter for the multimedia frames determined in the ascending capture order and the descending capture order, comparing the region-match parameters for these multimedia frames with the region-match parameter of the selected multimedia frame and choosing a multimedia frame from among the selected multimedia frame and corresponding multimedia frames in the ascending capture order and the descending capture order with the region-match parameter corresponding to substantial match with the selected region in the multimedia frame. As explained above, for the selected multimedia frames, a multimedia frame at a reduced pre-defined interval is determined in the ascending capture order and descending capture order. A region-match parameter, for example a SAD value, is computed for these multimedia frames and compared with the region-match parameter of the selected multimedia frame. A multimedia frame with region-match parameter corresponding to substantial match with the selected region in the multimedia frame (for example, a region-match parameter with lowest value of SAD among the three multimedia frames) may be chosen. For example, if frame number 8 is one of the selected multimedia frames and frame numbers 4 and 12 are the determined multimedia frames in the ascending capture order and the descending capture order at the pre-defined interval, respectively, then the region-match parameter is computed for frame numbers 4 and 12 and compared with the region-match parameter corresponding to frame number 8. The multimedia frame from among the three multimedia frames (for example, frame numbers 4, 8 and 12) with the region-match parameter corresponding to the closest match with the user-selected region is chosen. In an example embodiment, a multimedia frame is chosen for each selected multimedia frame. In an example embodiment, a multimedia frame is identified from among the chosen multimedia frames and multimedia frames neighbouring the chosen multimedia frames based on the computed region-match parameter.

In an example embodiment, identifying the multimedia frame further includes performing repeatedly for the chosen multimedia frames till the reduced pre-defined interval is greater than or equal to a pre-defined threshold interval: reducing the reduced pre-defined interval by the fractional value (for example, by ½); determining a multimedia frame occurring at the reduced pre-defined interval from the chosen multimedia frame in an ascending capture order and a descending capture order associated with the plurality of multimedia frames; computing the region-match parameters for the multimedia frames determined in the ascending capture order and the descending capture order; comparing the region-match parameters for the multimedia frames determined in the ascending capture order and the descending capture order with the region-match parameter for the chosen multimedia frame; and choosing a multimedia frame from among the chosen multimedia frame and corresponding multimedia frames in the ascending capture order and the descending capture order with the region-match parameter corresponding to substantial match with the selected region in the multimedia frame.

In an example embodiment, repeatedly performing identification of a multimedia frame in chosen multimedia frames and multimedia frames neighbouring the chosen multimedia frames till the pre-defined interval is greater than or equal to the pre-defined threshold interval may result in choosing one multimedia frame for each chosen multimedia frame. A multimedia frame with a region-match parameter providing best match with the user-selected region may be identified from among the chosen multimedia frames and used for loop sequence generation corresponding to the animated image.

In an example embodiment, the pre-defined threshold interval is one of an integer value and a non-integer value. In an example embodiment, the non-integer value of the pre-defined threshold corresponds to an intermediate multimedia frame generated by interpolating adjacent multimedia frames. In an example embodiment, the multimedia frame with the region-match parameter corresponding to substantial match with the selected region in the multimedia frame is identified from among the chosen multimedia frames.

The identification of the multimedia frame from the chosen multimedia frames is further explained by an illustrative example as follows: A video sequence comprising a plurality of multimedia frames (for example, frames numbered from 1 to N) may be displayed to a user, such that the multimedia frames are displayed in an on-going manner in an order of capture. One or more of the displayed multimedia frames may include region (s) of interest to the user. From among frame numbers 1 to N, a user may select a region in frame number 5. Multimedia frames occurring periodically at pre-defined interval, for example a pre-defined interval of four frames, starting from frame number 5, are aligned based on frame number 5. Accordingly, frame numbers 9, 13, 17, 21, 25 and so on and so forth are aligned. A region-match parameter may be computed for these aligned multimedia frames and those with desired match characteristics (for example, best-match characteristics) to the user-selected region are selected. For example, frame numbers 9, 17, 25 . . . are selected. The pre-defined interval is reduced, for example by ½ to be equal to interval of two frames, and multimedia frames are determined in ascending capture order and the descending capture order for each selected multimedia frame. Accordingly, for frame number 9, frame numbers 7 and 11 are determined (at the reduced pre-defined interval of two). A region-match parameter is computed for frame numbers 7 and 11 and compared with region-match parameter for frame number 9. If the frame number 7 has the region-match parameter corresponding to the closest match, then the frame number 7 is chosen and above steps are repeated by reducing the pre-defined interval till the pre-defined threshold interval is reached. For example, if the pre-defined interval is further halved to one, then frame numbers 6 and 8 are determined for frame number 7 and their region-match parameters are compared to identify the chosen frame. If frame number 6 is the chosen frame, then the reduced pre-defined interval is further reduced. If the pre-defined threshold interval is 0.5, e.g., a non-integer value, then for frame number 6, adjacent frames are interpolated to identify an intermediate multimedia frame. For example, frame numbers 5 and 6 (e.g. adjacent frames) are interpolated to generate a half-frame. Similarly, frame numbers 6 and 7 are interpolated to generate a half-frame. A region-match parameter may be computed for these half-frames and compared with the region-match parameter corresponding to frame number 6 and the multimedia frame with the best match characteristics with the user-selected region may be chosen. If the pre-defined threshold interval is 0.25, e.g., a non-integer value, then the reduced pre-defined interval is further reduced. If frame number 6 is the chosen frame, then for frame number 6, adjacent half-frames are interpolated to identify an intermediate frame. For example, half frames, for example frame 6 and frame 5.5 (e.g. half frame) are interpolated to generate a quarter-frame. Similarly, frame numbers 6 and 6.5 (e.g. half frame) are interpolated to generate a quarter-frame. A region-match parameter may be computed for these quarter-frames and compared with the region-match parameter corresponding to frame number 6 and the multimedia frame with the best match characteristics with the user-selected region may be chosen. The pre-defined threshold interval may similarly chosen to be any non-integer value, for example 0.3 or 0.7, and adjacent frames interpolated based on corresponding weightage (for example, 30% or 70%) to the non-integer value to generate intermediate multimedia frames and the search is then conducted to identify the multimedia frame with the best match characteristics with the user-selected region. In an example embodiment, one multimedia frame may be chosen for each selected multimedia frame and the multimedia frame among these chosen multimedia frames may be identified and utilized as the multimedia frame for terminating a loop sequence corresponding the animated image.

As can be seen above, the pre-defined threshold interval of non-integer values facilitates half-frame, quarter frame or such intermediate frame generation, respectively, for identification of the multimedia frame for configuring the loop sequence. In an example embodiment, a slight shake at the end of the loop sequence corresponding to the animated image may be observed if the pre-defined threshold interval is an integer value. In an embodiment, the pre-defined threshold interval may be set to an integer value and subsequently changed to a non-integer value for refinement purposes. In an example embodiment, a processing means may be configured to identify a multimedia frame from among the selected multimedia frames and multimedia frames neighbouring the selected multimedia frames based on the computed region-match parameters. An example of the processing means may include the processor 202, which may be an example of the controller 108.

In an example embodiment, the processor 202 is caused to, with the content of the memory 204, and optionally with other components described herein, to cause the apparatus 200 to provide one or more loop sequence options based on the selected region in the multimedia frame. The loop sequence generation involves identifying a periodicity in motion areas under consideration. In some multimedia frame sequences, a selected object may have multiple types of motions (e.g. multiple loops). In an example embodiment, loop sequence options may be provided to a user via a drop down menu or a pop-up menu, so that the user may change the looping points for animated image generation.

In an example embodiment, loop sequence options are provided based on a parameter value computed for one or more multimedia frames of the plurality of multimedia frames, where the parameter value for the one or more multimedia frames is computed corresponding to the selected region in the multimedia frame. Examples of parameter value may include a sum of squared differences (SSD) value, a SAD value or any such parameter value used for region-matching purposes. In an example embodiment, a smallest possible rectangle that best fits the region selected by the user is obtained. A parameter value is computed for all multimedia frames subsequent to the multimedia frame comprising the selected region, and the parameter value and the corresponding frame number are stored. The parameter values may be used to identify peak and valley points, where peak points refer to high parameter values and valley points refer to low parameter values. In an example embodiment, each valley point may signify a unique loop sequence and accordingly, the multimedia frames corresponding to the valley points of the parameter values may be used as starting points for loop configuration process. For example, a multimedia frame sequence may include a scene corresponding to multiple actions performed by a child. The parameter values may be computed for frames corresponding to each action and multimedia frames corresponding to valley points for the parameter values may be used as suggestion for loop sequence starting points. In an example embodiment, a processing means may be configured to provide one or more loop sequence options based on the selected region in the multimedia frame. An example of the processing means may include the processor 202, which may be an example of the controller 108.

In an example embodiment, the processor 202 is caused to, with the content of the memory 204, and optionally with other components described herein, to cause the apparatus 200 to generate the animated image for the loop sequence configured based on the identified multimedia frame and the multimedia frame comprising the selected region. In an embodiment, the animated image effect may refer to minor and repeated movement of at least one object observed in multimedia frames with the remaining portions as stationary. The animated image effect may be generated by creating a finite duration content that can be played continuously. In an example embodiment, the multimedia frame corresponding to the selected region (to be imparted with movement) may serve as a first frame in the loop sequence and the multimedia frame identified from among the chosen multimedia frames to include a region substantially matching the selected region may serve as the last frame in the loop sequence.

In an example embodiment, a static background portion (non-motion areas) in the multimedia frame associated with the selected region may be separated to form a static layer and combined with the loop sequence (motion areas) to generate the animated image effect. In an embodiment, image blending techniques may be utilized for combining the loop sequence with the static layer. The image blending techniques may involve cross fading or morphing across transitions. In an example embodiment, one or more loop sequence options may be identified based on parameter values and provided to the user for selection. The selected loop sequence option may be utilized for configuring the animated image. In an example embodiment, a processing means may be configured to generate the animated image for the loop sequence configured based on the identified multimedia frame and the multimedia frame comprising the selected region. An example of the processing means may include the processor 202, which may be an example of the controller 108.

In an example embodiment, the animated image is displayed at a first temporal resolution and subsequently the display of the animated image is refined to a second temporal resolution, wherein the second temporal resolution is greater than the first temporal resolution. For example, after generating the animated image based on the configured loop sequence, the animated image may be displayed to the user. Such an animated image may have lower temporal resolution on account on limited number of multimedia frames aligned therein. In an example embodiment, all the multimedia frames lying between the multimedia frame with the selected region and identified multimedia frame for loop sequence termination may be aligned, thereby refining the animated image effect. Such an animated image may include a higher temporal resolution. The animated image refined in such a manner may thereafter be displayed to the user. In an example embodiment, a processing means may be configured to display the animated image at a first temporal resolution and subsequently refine the display of the animated image to the second temporal resolution, where the second temporal resolution is greater than the first temporal resolution. An example of the processing means may include the processor 202, which may be an example of the controller 108.

In an example embodiment, the processor 202 is caused to, with the content of the memory 204, and optionally with other components described herein, to cause the apparatus 200 to facilitate control of a display rate associated with the animated image. In an example embodiment, a user may control a rate at which the animated image loops back while being displayed. In an example embodiment, a horizontal slider option may be provided to a user for controlling a rate of display associated with the animated image. In an example embodiment, a processing means may be configured to facilitate control of a display rate associated with the animated image. An example of the processing means may include the processor 202, which may be an example of the controller 108. A user interface depicting a motion map generated for indicating motion in a multimedia frame is explained in FIG. 3.

FIG. 3 illustrates a user interface (UI) 300 depicting a motion map generated for indicating motion in a multimedia frame for facilitating selection of a region in the multimedia frame in accordance with an example embodiment. The UI 300 may be employed in an apparatus, such as apparatus 200. In an embodiment, the UI 300 may be an example of the user interface 206 of the apparatus 200. The UI 300 is depicted to include a screen display area 302 and an option display area 304. In an embodiment, the screen display area 302 is configured to display multimedia content stored in the apparatus, for example in memory 204 of the apparatus 200. In an embodiment, the screen display area 302 may be configured to display scenes unfolding in surrounding environment. In an embodiment, scenes may be captured/recorded by an image sensor, for example the image sensor 208, or a camera and stored in the memory 204 as multimedia content.

In FIG. 3, the screen display area 302 displays a scene where a person and a child are seen waving a hand. Few individuals are also depicted to be walking in a background of the scene. The screen display 302 is also depicted to include a plurality of content playback options. During playback of multimedia content, scenes corresponding to a plurality of multimedia frames in the multimedia content are displayed in an on-going manner and the scene 306 may correspond to one such multimedia frame from among the plurality of multimedia frames. The content playback options depict a content slide bar 308, a rewind content tab 310, play content tab 312, a stop content tab 314, a forward content tab 316, a volume turn on/off tab 318 and a volume control slide bar 320. The content slide bar 308 is configured to provide an indication of time duration, or length, of multimedia content playback and also an indication of time elapsed from an initiation of playback for display of a current scene. In FIG. 3, the length for the multimedia content playback is displayed as 24.34 indicating a time duration of 24 minutes and 34 seconds and a time elapsed since initiation of the playback for display of the current scene to be 7.27 indicating a 7 minutes and 27 seconds time duration. The rewind content tab 310, the play content tab 312, the stop content tab 314, the forward content tab 316 are configured to reverse playback of multimedia content, initiate playback of multimedia content, stop playback of multimedia content and advance playback of the multimedia content, respectively. The volume turn/off tab 318 is configured to turn on or mute a sound component associated with the playback of the multimedia content and the volume control slide bar 320 is configured to enable a controlling of an intensity of the sound component associated with the playback of the multimedia content.

In FIG. 3, the options display area 304 is depicted to include a plurality of tabs, such as a selection tab (shown as ‘Sel’) 322, a save tab (shown as ‘Save’) 324, a mode selection tab (shown as ‘Mode’) 326, a selection undo tab (shown as ‘undo’) 328, a loop sequence selection tab (shown as ‘loop select’) 332 and a rate control tab (shown as ‘rate control) 334. The plurality of tabs in the options display area 304 are configured to facilitate selection of a region in a multimedia frame of the multimedia content in order to generate an animated image.

In an embodiment, the selection tab 322 is configured to facilitate selection of the region (for example, an object or a portion) of a scene being displayed on the screen display area 302. In an embodiment, upon selection of the selection tab 322, a playback of the content may be paused and a cursor or a pointer may appear on the screen display area 302 for enabling selection of the region of the scene. In an embodiment, the selection of the portion may be facilitated by user selection. In an embodiment, the region may be selected by pointing a pointing device, such as a mouse, at the portion on the UI 300, without even operating the selection tab 322. In various other embodiments, the selection may be performed by utilizing a touch screen user interface, a user gaze selection and the like. In an embodiment, the selection of the portion may indicate a choice of portion for imparting movement in the animated image. In an embodiment, the selection of the portion may indicate a choice of portion for retaining as stationary in the animated image. The remaining portions in the multimedia frame may be considered as the indication of the choice for imparting the movement in the animated image.

As explained in FIG. 2, a motion map for indicating motion areas present in a scene may be provided to a user to serve as a visual clue, so that the user may select the region (object/scenes of interest) with desired accuracy for generation of the animated image. In FIG. 3, bounding boxes, such as rectangles 330 shown in screen display area 302, may highlight the motion areas in the scene to provide the motion map to the user. The waving hand portions of the person and the child are depicted to be enveloped by the bounding boxes (rectangles 330) and serve as a visual clue for selecting the region for generating the animated image. In an example embodiment, multiple motion areas in a multimedia frame may be highlighted by different coloured boxes. For example, different coloured bounding boxes may be utilized for depicting the motion areas corresponding to the hand portion of the person and the child, respectively. In an example embodiment, the user may select the region by clicking inside the bounding box.

Further, as explained in FIG. 2, background subtraction may be performed for multimedia frames in the sequence to extract foreground regions, which may then be aggregated and filtered to form a binary image for generating the motion map. Bounding boxes with best fit around the motion maps may thereafter be displayed. Further, the selection tab 322 may facilitate receiving a user input for performing one of an addition and deletion of region associated with the generated motion map for selecting the region in the multimedia frame. For example, the selection tab 322 may enable the user to select desired region boundary within the bounding box.

In an embodiment, the save tab 324 may be configured to facilitate a saving of the selection of the region whereas the selection undo tab 328 may be configured to facilitate in reversing the last selected and/or saved options. For example, upon selecting the region within the rectangles 330, the user may decide to deselect the region, and instead select another region in the same or a different multimedia frame/scene. In an embodiment, the selection undo tab 328 may be operated for reversing the selection of the region, and thereafter another portion may be selected by operating the selection tab 322 in the option display area 304.

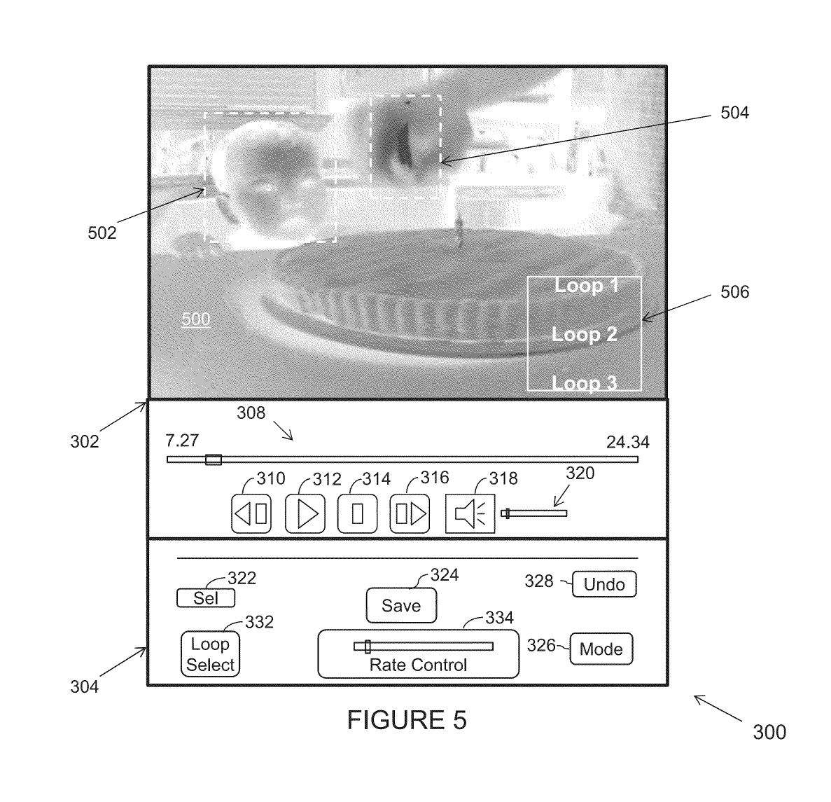

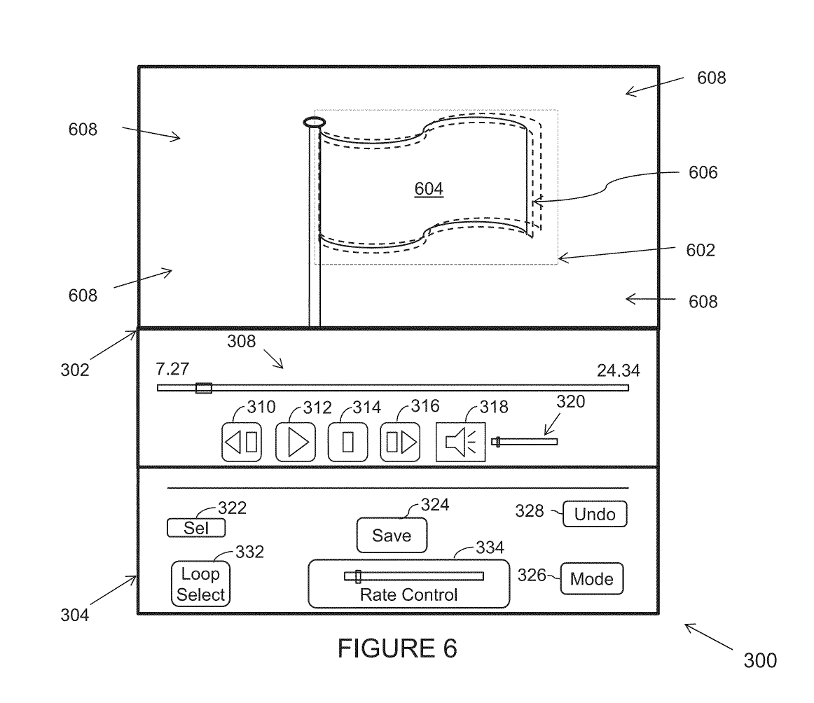

In an embodiment, the mode selection tab 326 may be configured to facilitate selection of one of viewfinder mode and a content playback mode. In an embodiment, the viewfinder mode may be utilized for viewing scenes unfolding in surrounding environment and further capturing the scene(s) as a still frame or a multimedia content, such as a sequence of video frames. In an embodiment, the playback mode may be utilized for displaying the captured multimedia content or any stored multimedia content. In an embodiment, the loop select tab 332 may be configured to facilitate selection of loop sequence from among one or more loop sequence options provided to a user based on the selected region. The provision of loop sequence options is explained in FIG. 5. In an embodiment, the rate control tab 332 may be configured to facilitate controlling of a rate associated with an animated image. The controlling of the rate associated with the animated image is explained in FIG. 6.

In an embodiment, selection of various tabs, for example, the selection tab 322, the save tab 324, the selection undo tab 328, mode selection tab 326, the loop select tab 332 and the rate control tab 334 may be facilitated by a user action. Also, as disclosed herein in various embodiments, various options being displayed in the options display area 304 are represented by tabs. It will however be understood that these options may be displayed or represented in various devices by various other means, such as push buttons, and user selectable arrangements. In an embodiment, selection of the portion and various other options in the UI, for example the UI 300, may be performed by, for example, a mouse-click, a touch screen user interface, detection of a gaze of a user and the like.

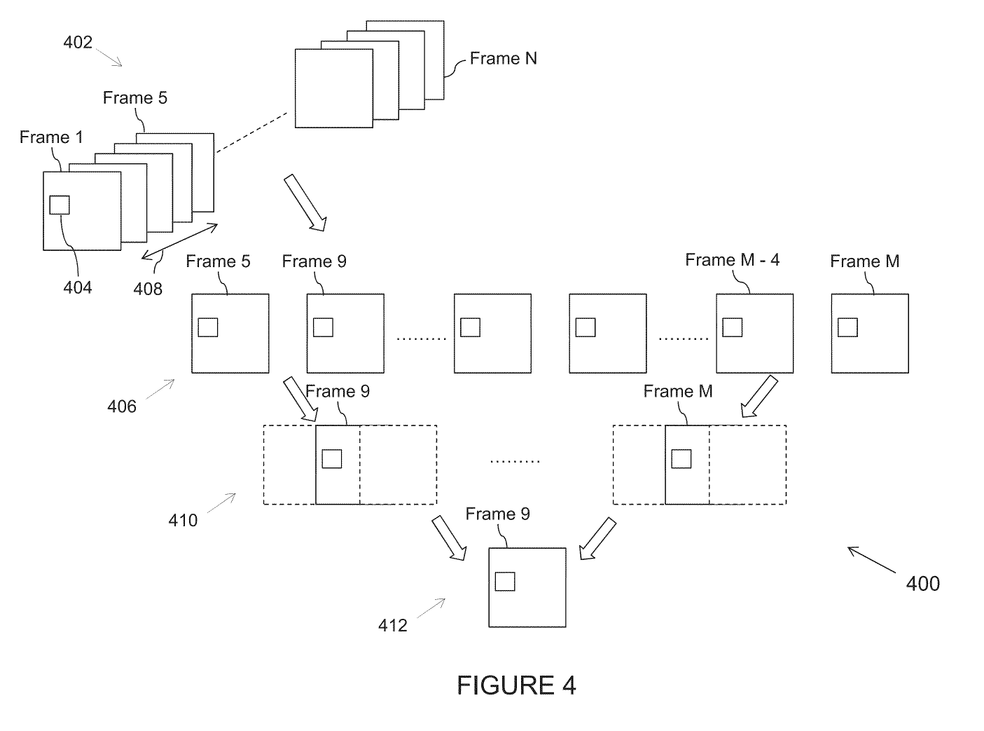

FIG. 4 illustrates a logical sequence 400 for identifying a multimedia frame for configuring a loop sequence for an animated image in accordance with an example embodiment. In an embodiment, the logical sequence 400 may be employed by the apparatus 200 for identifying the multimedia frame. In FIG. 4, the multimedia frames are depicted to be referred to as frames. For example, multimedia frame 1 is referred to frame 1, multimedia frame 5 is referred to as frame 5 and so on and so forth. The sequence 400 starts at 402. At 402, a selection of a region 404 in a multimedia frame (for example, frame 1) from among a plurality of multimedia frames (for example, frames 1 to N) is received from a user. The plurality of multimedia frames 1 to N is depicted to be in an order of capture, for example from an image sensor, for example the image sensor 208 of the apparatus 200. The selection of the region 404 in the frame 1 may be facilitated using a motion map, as explained in FIG. 3.

At 406, an alignment of multimedia frames occurring periodically at a pre-defined interval 408 in a capture order associated with the plurality of multimedia frames is performed. The alignment of the multimedia frames may involve aligning similar content across the multimedia frames and removing jitter introduced either on account of movement of media capture medium (e.g., from being handheld) or on account of transient environmental conditions, such as high wind conditions, during the capture of the multimedia content. Two-dimensional (2D) and three-dimensional (3D) multimedia stabilization algorithms may be employed for performing the alignment. In an embodiment, the alignment is performed based on the multimedia frame comprising the selected region. For example, if the pre-defined interval 408 corresponds to four frames, then every fourth frame may be aligned with respect to frame 1. Accordingly, frame 5, frame 9 till frame M may be aligned with respect to frame 1.

A region-match parameter may be computed for the aligned multimedia frames with respect to the selected region 404. As explained in FIG. 2, the region-match parameter is configured to provide an indication of a degree of match between the selected region in the multimedia frame and similar regions in aligned multimedia frames. In an example embodiment, the region-match parameter is a sum of absolute differences (SAD) value. In an example embodiment, a SAD value for corresponding regions in the aligned multimedia frames is computed. In an example embodiment, a lower SAD value may correspond to a higher degree of match between corresponding regions in an aligned multimedia frame and the multimedia frame with the selected region.

At 410, one or more multimedia frames are selected from among the aligned multimedia frames based on the computed region-match parameter. Based on region-match parameter, aligned multimedia frames with the closest match to the selected region may be selected. For example, SAD values corresponding to regions similar to the selected region are computed in the aligned multimedia frames and compared, and the aligned multimedia frames with best match characteristics (low SAD values) may be selected. In an example embodiment, 10% of the aligned multimedia frames with lowest SAD values may be selected for loop sequence consideration. In FIG. 4, according to an example embodiment, frame 9 and frame M are depicted to selected from among the aligned multimedia frames.

At 412, a multimedia frame is identified from among the selected multimedia frames and multimedia frames neighboring the selected multimedia frames based on the computed region-match parameters. The multimedia frame is identified for configuring a loop sequence for an animated image. As explained in FIG. 2, identification of the multimedia frame from the selected multimedia frames may involve reducing the pre-defined interval by a fractional value and determining a multimedia frame occurring at the reduced pre-defined interval from the selected multimedia frame in an ascending capture order and a descending capture order. For example, the pre-defined interval 408 of 4 frames may be halved and a multimedia frame determined at interval of two frames in ascending capture order and descending capture order. For example, in FIG. 4, frames 7 and 11 may be determined at reduced pre-defined interval of two units in each direction of the capture order from selected frame 9. A region-match parameter may be computed for frames 7 and 11 and compared with region-match parameter corresponding to frame 9. The multimedia frame with the region-match parameter corresponding to a substantial match with the user-selected region may be chosen. Accordingly, a multimedia frame may be chosen for each selected multimedia frame. In an embodiment, a multimedia frame with the best-match characteristics for the region-match parameter may be identified from among the chosen multimedia frames (corresponding to the selected multimedia frames) and used for loop sequence generation.

In an embodiment, the reduced pre-defined interval is further reduced and multimedia frames at the reduced pre-defined interval are determined for each chosen multimedia frame. For example, if frame 9 is chosen from frames 7, 9 and 11 with desired match (for example, best match) characteristics corresponding to the region-match parameter, and the pre-defined interval is further halved to one frame, then frames 8 and 10 are determined for frame 9 in ascending capture order and descending capture order, respectively. A region-match parameter may be computed for frames 8 and 10 and compared with region-match parameter corresponding to frame 9. The multimedia frame with the region-match parameter corresponding to a substantial match with the user-selected region may be chosen. The pre-defined interval may further be reduced and process can be repeated till the pre-defined interval is equal to or greater than a pre-defined threshold interval. In an example embodiment, the pre-defined threshold interval is a non-integer value and corresponds to 0.5. Accordingly, if frame 9 is chosen from among frames 8, 9 and 10 to be the multimedia frame with best match characteristics corresponding to the region-match parameter, and the pre-defined interval is further halved to 0.5, then adjacent multimedia frames 8 and 9 and multimedia frames 9 and 10 are interpolated to generate half frames (for example, represented by 8.5 and 9.5) in ascending capture order and descending capture order, respectively. A region-match parameter may be computed for half-frames 8.5 and 9.5 and compared with region-match parameter corresponding to frame 9. In an example embodiment, the pre-defined threshold interval is a non-integer value and corresponds to 0.25. Accordingly, if frame 9 is chosen from among frames 8.5, 9 and 9.5 to be the multimedia frame with best match characteristics corresponding to the region-match parameter, and the pre-defined interval is further halved to 0.25, then adjacent multimedia frames 8.5 and 9 and multimedia frames 9 and 9.5 are interpolated to generate quarter frames (for example, represented by 8.75 and 9.25) in ascending capture order and descending capture order, respectively. A region-match parameter may be computed for quarter-frames 8.75 and 9.25 and compared with region-match parameter corresponding to frame 9. The multimedia frame with the region-match parameter corresponding to a substantial match with the user-selected region may be chosen. Accordingly, a multimedia frame may be chosen for each chosen multimedia frame. The chosen multimedia frames may be compared for region-match parameter corresponding to the user-selected region and a multimedia frame among them identified for loop sequence generation.

In FIG. 4, frame 9 is depicted to be identified with best match characteristics of region-match parameter and is utilized for loop sequence configuration. The animated image is generated accordingly with the loop sequence from frame 1 (frame with user-selected region) to frame 9 (frame identified with best-match characteristics for the region-match parameter). In an example embodiment, the generated animated image is displayed with the only select multimedia frames at pre-defined interval aligned, as performed earlier. Accordingly, such an animated image may have a first resolution (for example, a lower resolution). Subsequently, all multimedia frames from frame 1 to frame 9 may be aligned and displayed at a second resolution (for example, a higher resolution) to a user.

FIG. 5 illustrates a user interface (UI) 300 depicting a provisioning of multiple loop sequence options based on the selected region in the multimedia frame in accordance with an example embodiment. In FIG. 5, the generated motion map depicts two bounding boxes, such as rectangles 502 and 504, indicating motion areas in the scene 500 displayed on the UI 300. The motion areas correspond to movements of facial expressions of a child (enveloped within rectangle 502) and a flickering of a candle portion (enveloped within rectangle 504). On clicking within the rectangle 502, loop sequence options, such as loop 1, loop 2 and loop 3 displayed within a pop-up 506 on the screen display area 302 may be provided to the user. The user may select any of the three loop sequence options by using the tab loop select 332 on the options display area 304. The loop sequences may correspond to different facial expressions of the child. In absence of such a provisioning of the loop sequence option, a user may have to slide across the plurality of multimedia frames and select a region corresponding to a particular facial expression for generation of the animated image, which may be un-intuitive.

As explained in FIG. 2, loop sequence options are provided based on a parameter value computed for one or more multimedia frames of the plurality of multimedia frames, where the parameter value for the one or more multimedia frames is computed corresponding to the selected region in the multimedia frame. As explained in FIG. 2, the parameter values may be used to identify peak and valley points, where peak points refer to high parameter values and valley points refer to low parameter values. In an example embodiment, each valley point may signify a unique loop sequence and accordingly, the multimedia frames corresponding to the valley points of the parameter values may be used as starting points for loop configuration process. The parameter values may be computed for frames corresponding to each action and multimedia frames corresponding to valley points for the parameter values may be used as suggestion for loop sequence starting points. Based on the selected loop sequence, the animated image may be generated. An animated image is explained in FIG. 6.

FIG. 6 illustrates an animated image 600 in accordance with an example embodiment. The animated image 600 includes a region 602 including the flag portion 604 performing minor and repeated movement (as depicted by the waving 606 of the flag portion 604). The remaining portions 608 of the animated image 600 are retained as stationary in the animated image 600.

The selection of the region 602 in a multimedia frame corresponding to a scene being displayed on a UI, such as the UI 300, may be performed as explained in FIG. 3. In an embodiment, upon selection of the region, multimedia frames occurring periodically at a pre-defined interval in a capture order associated with the plurality of multimedia frames may be aligned based on the multimedia frame comprising the selected region. Region-match parameters corresponding to the selected region in the multimedia frame may be computed for the aligned multimedia frames. One or more multimedia frames may be selected from among the aligned multimedia frames based on the computed region-match parameters. A multimedia frame may thereafter be identified from among the selected one or more multimedia frames and multimedia frames neighbouring the one or more selected multimedia frames based on the computed region-match parameters. The identified multimedia frame may be utilized for configuring a loop sequence. An animated image, such as the animated image 600, may be generated for the loop sequence configured based on the identified multimedia frame and the multimedia frame comprising the selected region.

As explained in FIGS. 2 and 3, controlling of a display rate associated with an animated image, such as animated image 600, may be facilitated, such that a user may control a rate at which the animated image loops back while being displayed. In FIG. 6, a horizontal slider option is provided with the rate control tab 334 to enable a user to control a rate of display associated with the animated image 600. In an example embodiment, a rightward movement of the horizontal slider may increase a display rate associated with the animated image 600 (for example, increasing the display rate may be associated with increased rate of waving 606 of the flag portion 604), while a leftward movement of the horizontal slider may decrease a display rate associated with the animated image 600 (for example, decreasing the display rate may be associated with slowing down a rate of waving 606 of the flag portion 604).

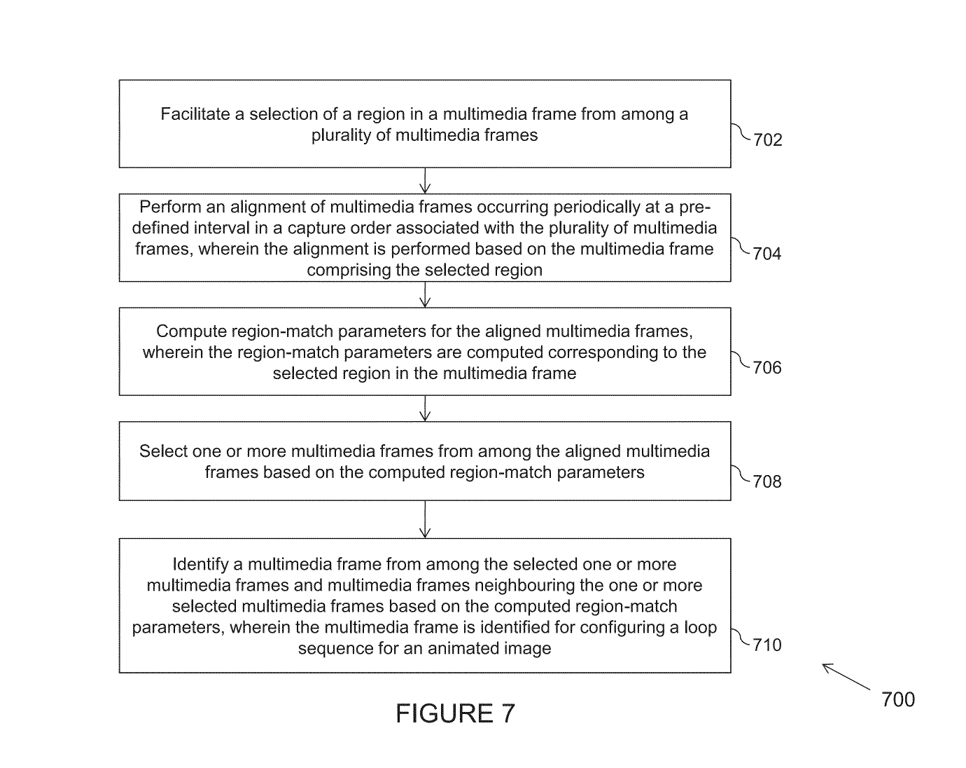

FIG. 7 is a flowchart depicting an example method 700 for generating an animated image, in accordance with an example embodiment. The method depicted in the flow chart may be executed by, for example, the apparatus 200 of FIG. 2. In an embodiment, a multimedia frame providing a desired match (for example, best match) to a user-selected region in a multimedia frame may be identified and used for configuring a loop sequence. The animated image may be generated based on the configured loop sequence.

At block 702, a selection of a region in a multimedia frame from among a plurality of multimedia frames is facilitated. In an embodiment, the selection of the region comprises selection of at least one of an object (for example, a person, an entity or an article) and a portion (for example, an area or a section) in a multimedia frame for imparting movement in an animation image to be generated from the plurality of multimedia frames. For example, the plurality of multimedia frames may depict a scene where a news reporter is presenting a commentary in breezy environmental conditions. One or more multimedia frames may depict a blowing of a hair portion of the news reporter while presenting the commentary. An object in the multimedia frame, for example the news reporter, or a region in the multimedia frame, for example an area in the multimedia frame depicting blowing of the hair portion may be selected for imparting repeated movement in the animated image. In an embodiment, the selection of the region in the multimedia region may be facilitated for rendering the object/portion stationary with non-selected regions imparted with movement in the animated image. In an embodiment, the selection of the region is performed based on a user input. In an embodiment, the user input is facilitated by one of a mouse click, a touch screen command, and a user gaze. In an embodiment, the user may utilize a user interface, such as the user interface 206, for providing the selection of the region in the multimedia frame for imparting movement in the animated image. In an embodiment, the selected portion may appear highlighted. In an embodiment, the selection of the region is performed without input from the user. For example, the region may be automatically selected based on various pre-defined criteria. For example, the selection of region can be performed based on a keyword. For example, if a user wants to select a region depicting a car, the user may provide input as keyword ‘car’ and the region depicting car may be selected, for example, by performing object detection. In an embodiment, the user interface may be configured to receive the keywords as input.

In an example embodiment, a motion map for indicating motion in one or more multimedia frames is generated for facilitating selection of the region in the multimedia frame. In an example embodiment, a motion map is a visual representation associated with multimedia frames where one or more areas motion areas are identified and highlighted, for example by bounding boxes such as a rectangle (as explained in FIG. 3). In an embodiment, a user may not be aware of multiple motion areas in a scene that he/she has captured. The motion map provides a visual clue for motion areas in a multimedia frame to make selection of the region for configuration of the animated image intuitive. In an example embodiment, multiple motion areas in a multimedia frame may be highlighted by different coloured boxes. In an example embodiment, the user may select the region by clicking inside the bounding box.

In an example embodiment, a background subtraction (or removal) of multimedia frames may be performed. The background subtraction of multimedia frames may involve subtracting multimedia frame from an average frame computed from a plurality of multimedia frames to extract foreground regions in a binary image format. These foreground regions may correspond to motion area(s). In an embodiment, all the binary images corresponding to the foreground regions may be aggregated into one image to represent the motion map for motion areas in the multimedia frame sequence. In an example embodiment, a morphological filtering may be performed to remove noise present in the aggregated image. In an example embodiment, a connected component labelling may be performed to differentiate the motion maps of different regions. A size filtering may be performed to allow display of only dominant motion maps while suppressing the insignificant/smaller motion maps. Bounding boxes with best fit around the motion maps may thereafter be displayed. In an example embodiment, multiple motion maps (for example, bounding boxes) may be provided for facilitating selection of the region.

In an example embodiment, the motion areas may be estimated based on one of image frequency analysis and block-matching algorithms. In an embodiment, detection of motion in the plurality of multimedia frames is performed by analyzing an optical flow pattern. The optical flow pattern may refer to a pattern of apparent motion of objects, surfaces, and edges in a scene. Upon computing the optical flow pattern, motion areas may be determined by analyzing a flow field, for example, by utilizing thresholding techniques.

In an example embodiment, receiving a user input for performing one of an addition and deletion of region associated with the generated motion map is facilitated for selecting the region in the multimedia frame. For example, in some cases, the motion map may not capture regions associated with motion in the multimedia frames with desired accuracy and the motion areas may exceed the region encompassed by a bounding box corresponding to the motion map or the bounding box may be too large for an associated motion area. In an example embodiment, the addition or the deletion of the region associated with the generated motion map may be facilitated through a segmented view of the region. In an embodiment, similar pixels in a multimedia frame are grouped into one super pixel to configure segments and the user can fine tune by either deselecting the already selected segments or by selecting new ones, thereby performing the requisite addition/deletion of the region associated with the generated motion map. For example, user might be interested only in movement of a hair portion as opposed to an entire face portion. In such a scenario, finer selection is possible by allowing the user to select region boundary (by selecting/deselecting segments) within bigger bounding box. In an embodiment, desired selection may be achieved based on object detection, for example, face detection. In an embodiment, the user may provide input as ‘face’. If a user wants to select a specific face, keywords for example, name of the person and ‘face’ may be provided as input. Accordingly, face identification may be performed to select the region. In an example embodiment, user interface, such as the user interface 206 is configured to receive the keywords as input.

At block 704, an alignment of multimedia frames occurring periodically at a pre-defined interval in a capture order associated with the plurality of multimedia frames is performed. In an embodiment, the alignment is performed based on the multimedia frame comprising the selected region. For example, if the pre-defined interval corresponds to five multimedia frames, then multimedia frame numbers 6, 11, 16, 21 and so on and so forth may be aligned with respect to the multimedia frame number 1 (e.g. multimedia frame including the selected region). The alignment of the multimedia frames may involve aligning similar content across the multimedia frames and removing jitter introduced either on account of movement of media capture medium (e.g., from being handheld) or on account of transient environmental conditions, such as high wind conditions, during the capture of the multimedia content. Two-dimensional (2D) and three-dimensional (3D) multimedia stabilization algorithms may be employed for performing the alignment. In an embodiment, the 2D algorithms may estimate camera motion in the 2D image plane motion and zoom or crop to compensate. The motion may be evaluated in a variety of ways, including optical flow, stable feature points, and block-based cross-correlation. In an embodiment, 3D video stabilization algorithms may identify stable 3D feature points by structure-from-motion and apply image based or warping techniques to cope with parallax effect.

At block 706, region-match parameters corresponding to the selected region in the multimedia frame are computed for the aligned multimedia frames. In an example embodiment, a region-match parameter is configured to provide an indication of a degree of match between the selected region in the multimedia frame and a similar region in an aligned multimedia frame. In an example embodiment, the region-match parameters are sum of absolute differences (SAD) values. In an example embodiment, SAD value for regions in the aligned multimedia frames corresponding to the selected region in the multimedia frame are computed. In an example embodiment, a lower SAD value may correspond to a higher degree of match between corresponding regions in an aligned multimedia frame and the multimedia frame with the selected region.

At block 708, one or more multimedia frames are selected from among the aligned multimedia frames based on the computed region-match parameters. Based on the region-match parameters, aligned multimedia frames with the closest match to the selected region may be selected. For example, SAD values corresponding to regions similar to the selected region are computed in the aligned multimedia frames and compared, and the aligned multimedia frames with best match characteristics (low SAD values) may be selected. For example, if multimedia frame numbers 6, 11, 16, 21 . . . N, are aligned with respect to multimedia frame 1, and SAD values corresponding to regions similar to the selected region are computed and compared, then the aligned multimedia frames with best match characteristics (low SAD values) may be selected. In an example embodiment, an upper limit on a number of multimedia frames to be selected may be defined. For example, 10% of the aligned multimedia frames with lowest SAD values may be selected for loop sequence consideration. For example, if 300 multimedia frames are aligned, then 30 multimedia frames (10%) with low SAD values may be selected from the aligned multimedia frames. It is noted that a smaller or a higher percentage of multimedia frames with lowest SAD values may be selected from among the aligned multimedia frames.

At block 710, a multimedia frame is identified from among the selected one or more multimedia frames and multimedia frames neighbouring the one or more selected multimedia frames based on the computed region-match parameters. For example, if multimedia frame numbers 6, 15, 26 . . . M in the capture order associated with the plurality of multimedia frames are selected based on the region-match parameters, then a multimedia frame is identified from among these selected multimedia frames and multimedia frames neighbouring the selected multimedia frames, such as multimedia frames neighbouring multimedia frame number 6; multimedia frames neighbouring multimedia frame number 15 and the like. The multimedia frame is identified for configuring a loop sequence for an animated image.

In an example embodiment, identifying the multimedia frame further includes performing for the selected one or more multimedia frames: reducing the pre-defined interval by a fractional value and determining a multimedia frame occurring at the reduced pre-defined interval from the selected multimedia frame in an ascending capture order and a descending capture order associated with the plurality of multimedia frames. In an example embodiment, the fractional value may be ½ and the pre-defined interval may be reduced to ½ its value. It should be noted that the fractional value of ½ is provided for exemplary purposes and the fractional value may be any such value lesser or greater than ½. For example, if the pre-defined interval of 8 frames was chosen for performing alignment of multimedia frames, then pre-defined interval may be reduced to ½×8=4 frames, and accordingly multimedia frames at the reduced pre-defined interval (for example, interval of 4 frames) may be determined in ascending capture order and descending capture order for the selected multimedia frames.

In an example embodiment, identifying the multimedia frame further includes performing for the selected one or more multimedia frames: computing the region-match parameter for the multimedia frames determined in the ascending capture order and the descending capture order, comparing the region-match parameter for these multimedia frames with the region-match parameter of the selected multimedia frame and choosing a multimedia frame from among the selected multimedia frame and corresponding multimedia frames in the ascending capture order and the descending capture order with the region-match parameter corresponding to substantial match with the selected region in the multimedia frame. As explained above, for selected multimedia frames, a multimedia frame at a reduced pre-defined interval is determined in the ascending capture order and descending capture order. A region-match parameter, for example a SAD value, is computed for these multimedia frames and compared with the region-match parameter of the selected multimedia frame. A multimedia frame with region-match parameter corresponding to substantial match with the selected region in the multimedia frame (e.g., a region-match parameter with lowest value of SAD among the three multimedia frames) may be chosen.

As explained, a multimedia frame is chosen for each selected multimedia frame. For the chosen multimedia frames, the pre-defined interval is further reduced (for example, by ½), multimedia frames determined at the reduced pre-defined interval in an ascending and descending capture order, region-match parameter computed for the determined multimedia frames and compared with the chosen multimedia frames and the multimedia frame with the region-match parameter closest to the user-selected region may be chosen and the process repeated till the reduced pre-defined interval is greater or equal to the pre-defined threshold. In an example embodiment, the pre-defined threshold interval is one of an integer value and a non-integer value. In an example embodiment, the non-integer value of the pre-defined threshold corresponds an intermediate multimedia frame generated by interpolating adjacent multimedia frames. In an example embodiment, the multimedia frame with the region-match parameter corresponding to substantial match with the selected region in the multimedia frame is identified from among the chosen multimedia frames. The pre-defined threshold interval of non-integer values, such as 0.5 or 0.25 facilitates half-frame or quarter frame generation (as explained in FIG. 2), respectively for identification of the multimedia frame for configuring the loop sequence. In an example embodiment, a slight shake at the end of the loop sequence corresponding to the animated image may be observed if the pre-defined threshold interval is an integer value. In an embodiment, the pre-defined threshold interval may be set to an integer value and subsequently changed to a non-integer value for refinement purposes.

In an example embodiment, one or more loop sequence options may be provided based on the selected region in the multimedia frame. The loop sequence generation involves identifying a periodicity in a motion area under consideration. In some multimedia frame sequences, a selected object may have multiple types of motions (e.g. multiple loops). In an example embodiment, loop sequence options may be provided to a user via a drop down menu or a pop-up menu as explained in FIG. 5, so that the user may change the looping points to create animated image.

In an example embodiment, loop sequence options are provided based on a parameter value computed for one or more multimedia frames of the plurality of multimedia frames, where the parameter value for the one or more multimedia frames is computed corresponding to the selected region in the multimedia frame. Examples of parameter value may include a sum of squared differences (SSD) value, a SAD value or any such parameter value used for region-matching purposes. In an example embodiment, a smallest possible rectangle that best fits the region selected by the user is obtained. A parameter value is computed for all multimedia frames subsequent to the multimedia frame comprising the selected region, and the parameter value and the corresponding frame number are stored. The parameter values may be used to identify peak and valley points, where peak points refer to high parameter values and valley points refer to low parameter values. In an example embodiment, each valley point may signify a unique loop sequence and accordingly, the multimedia frames corresponding to the valley points of the parameter values may be used as starting points for loop generation process (as explained in FIG. 5).

In an example embodiment, the animated image is generated for the loop sequence configured based on the identified multimedia frame and the multimedia frame comprising the selected region. In an embodiment, the animated image effect may refer to minor and repeated movement of at least one object observed in image content with the remaining portions as stationary. The animated image effect may be generated by creating finite duration content that can be played continuously. In an example embodiment, the multimedia frame corresponding to the selected region (to be imparted with movement) may serve as a first frame in the loop sequence and the multimedia frame identified from among the chosen multimedia frames to include a region substantially matching the selected region may serve as the last frame in the loop sequence corresponding to the animated image.

In an example embodiment, a static background portion (non-motion areas) in the multimedia frame associated with the selected region may be separated to form a static layer and combined with the loop sequence (motion areas) to generate the animated image effect. In an embodiment, image blending techniques may be utilized for combining the loop sequence with the static layer. The image blending techniques may involve cross fading or morphing across transitions. In an example embodiment, one or more loop sequence options may be identified based on parameter values and provided to the user for selection. The selected loop sequence option may be utilized for generating the animated image.

In an example embodiment, the animated image is displayed at a first temporal resolution and subsequently the display of the animated image is refined to a second temporal resolution, wherein the second temporal resolution is greater than the first temporal resolution. For example, after generating the animated image based on the loop sequence, the animated image may be displayed to the user. Such an animated image may have lower temporal resolution on account on limited number of multimedia frames aligned therein. In an example embodiment, all the multimedia frames lying between the multimedia frame with the selected region and identified multimedia frame for loop sequence termination may be aligned, thereby refining the animated image effect. Such an animated image may include a higher temporal resolution. The animated image refined in such a manner may thereafter be displayed to the user.

In an example embodiment, a control of a display rate associated with the animated image may be facilitated. In an example embodiment, a user may control a rate at which the animated image loops back while being displayed. In an example embodiment, a horizontal slider option, as explained in FIG. 6, may be provided to a user for controlling a rate of display associated with the animated image.

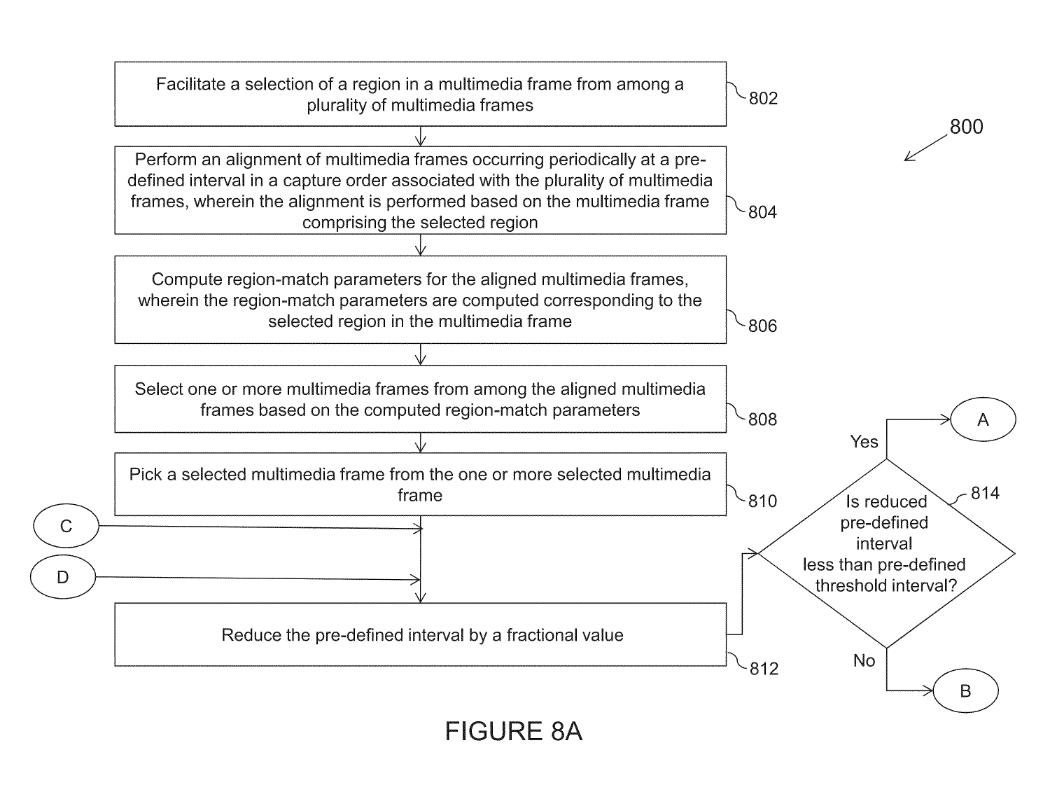

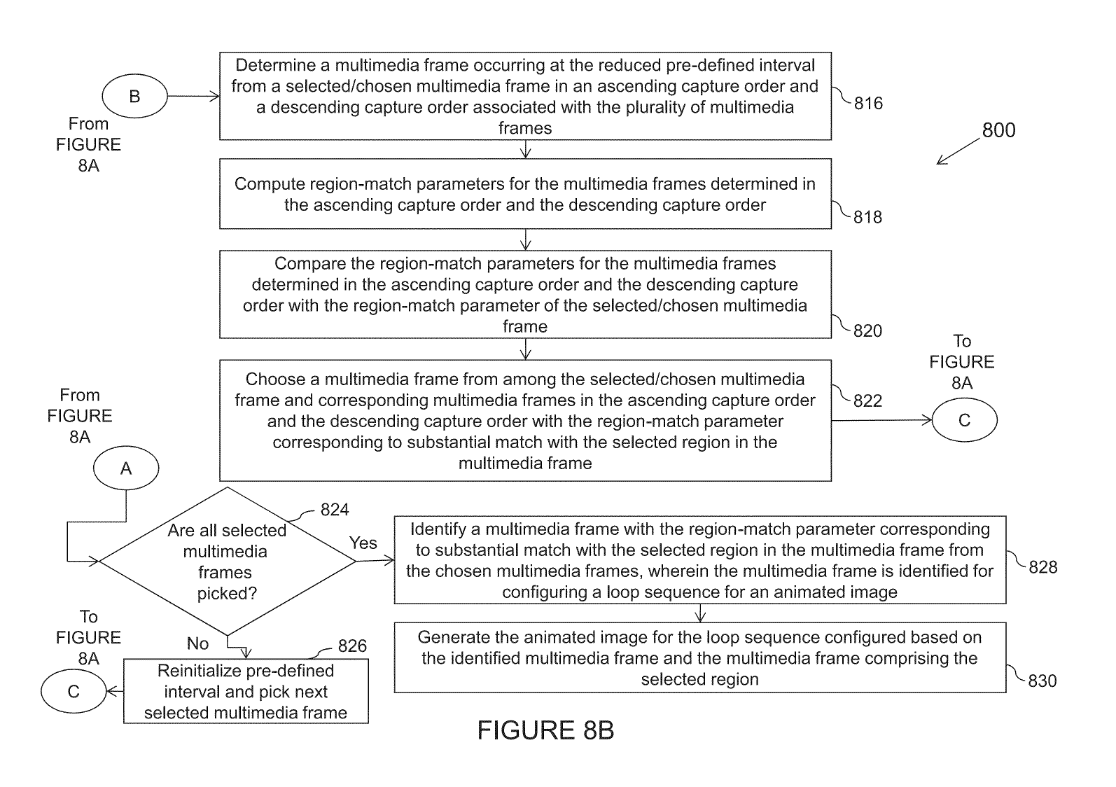

In an example embodiment, a processing means may be configured to perform some or all of: facilitating a selection of a region in a multimedia frame from among a plurality of multimedia frames; performing an alignment of multimedia frames occurring periodically at a pre-defined interval in a capture order associated with the plurality of multimedia frames, wherein the alignment is performed based on the multimedia frame comprising the selected region; computing region-match parameters for the aligned multimedia frames, wherein the region-match parameters are computed corresponding to the selected region in the multimedia frame; selecting one or more multimedia frames from among the aligned multimedia frames based on the computed region-match parameters; and identifying a multimedia frame from among the selected one or more multimedia frames and multimedia frames neighbouring the one or more selected multimedia frames based on the computed region-match parameters, wherein the multimedia frame is identified for generating a loop sequence corresponding to an animated image. An example of the processing means may include the processor 202, which may be an example of the controller 108. Another method for generating an animated image is explained in detail with reference to FIGS. 8A and 8B.

FIGS. 8A and 8B illustrates a flowchart depicting an example method 800 for generating an animated image, in accordance with another example embodiment. The method 800 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 800 are described with help of apparatus 200. However, the operations of the method can be described and/or practiced by using any other apparatus.

At blocks 802-808, a selection of a region in a multimedia frame from among a plurality of multimedia frames is facilitated, an alignment of multimedia frames occurring periodically at a pre-defined interval in a capture order associated with the plurality of multimedia frames is performed based on the multimedia frame comprising the selected region, region-match parameters corresponding to the selected region in the multimedia frame are computed for the aligned multimedia frames and one or more multimedia frames are selected from among the aligned multimedia frames based on the computed region-match parameters, respectively. The various operations and their embodiments at blocks 802-808 may be performed as explained at blocks 702-708 of FIG. 7.

At block 810, a selected multimedia frame from one or more multimedia frames is picked (e.g. selected). At block 812, the pre-defined interval is reduced by a fractional value (for example, the pre-defined interval is halved). At block 814, it is checked whether the reduced pre-defined threshold is less than a pre-defined threshold interval. In an example embodiment, the pre-defined threshold interval is one of an integer value and a non-integer value. In an example embodiment, a non-integer value of the pre-defined threshold corresponds a multimedia frame generated by interpolating adjacent multimedia frames. If the reduced pre-defined threshold is less than pre-defined threshold interval, then at block 824 it is checked whether all selected multimedia frames are picked. If the reduced pre-defined threshold is greater than or equal to pre-defined threshold interval, then at block 816, a multimedia frame occurring at the reduced pre-defined interval from a selected multimedia frame in an ascending capture order and a descending capture order associated with the plurality of multimedia frames is determined. At block 818, the region-match parameter is computed for the multimedia frames determined in the ascending capture order and the descending capture order. At block 820, the region-match parameter for the multimedia frames determined in the ascending capture order and the descending capture order is compared with the region-match parameter of the selected multimedia frame. At block 822, a multimedia frame is chosen from among the selected multimedia frame and corresponding multimedia frames in the ascending capture order and the descending capture order with the region-match parameter corresponding to substantial match with the selected region in the multimedia frame. Thereafter, the blocks 812 to 822 are repeatedly performed till the pre-defined threshold is less than the pre-defined threshold interval.

Upon determining at 814, that the pre-defined interval is less than the pre-defined threshold interval, at block 824 it is checked whether all selected multimedia frames are picked. If all multimedia frames are not picked then at block 826, the pre-defined interval is reinitialized to its earliest value (for each newly picked multimedia frame) and blocks 812-822 are repeated until multimedia frames are chosen for all selected multimedia frames. At block 828, a multimedia frame with the region-match parameter corresponding to substantial match with the selected region in the multimedia frame is identified from the chosen multimedia frames. In an embodiment, the multimedia frame is identified for configuring a loop sequence for an animated image. At block 828, an animated image is generated for the loop sequence configured based on the identified multimedia frame and the multimedia frame comprising the selected region.

To facilitate discussion of the method 800 of FIGS. 8A and 8B, certain operations are described herein as constituting distinct steps performed in a certain order. Such implementations are exemplary and non-limiting. Certain operation may be grouped together and performed in a single operation, and certain operations can be performed in an order that differs from the order employed in the examples set forth herein. Moreover, certain operations of the method 800 are performed in an automated fashion. These operations involve substantially no interaction with the user. Other operations of the method 800 may be performed by in a manual fashion or semi-automatic fashion. These operations involve interaction with the user via one or more user interface presentations.

Without in any way limiting the scope, interpretation, or application of the claims appearing below, a technical effect of one or more of the example embodiments disclosed herein is to generate animated images. As explained in FIGS. 2-8, animated images are short, seamlessly looping animated graphics interchange format images created from multimedia content, such as video content, in which only parts of the image move. Animated image, also referred to as a cinemagraph, capture the dynamics of one particular region in an image for dramatic effect, and provide control over what part of a moment to capture. The animated image enables capturing the dynamics of a moment, for example a waving of a flag or two people shaking hands, in a manner a still image or a video content cannot capture. Generation of the animated image requires identifying a multimedia frame matching the multimedia frame including the user-selected region and then aligning all multimedia frames therein. Performing alignment of multimedia frames, selectively (for example, aligning frames occurring periodically at pre-defined intervals) and identifying the multimedia frame for loop sequence generation reduces complexity and enables quicker generation of the animated images. Animated images generated in such a manner may be refined subsequently by aligning all interim multimedia frames. Further, the pre-defined threshold interval of non-integer values, such as 0.5 or 0.25, facilitates half-frame, quarter frame or such intermediate multimedia frame generation, for identification of the multimedia frame for configuring the loop sequence, thereby precluding shakes in animated images and improving an overall quality of the generated animated images. Also, motion maps (as explained in FIG. 3) aids in user selection for animated image generation. Furthermore, loop sequence options (as explained in FIG. 5) precludes un-intuitive search for suitable region for animated image generation and provides a user with options for creating multiple animated images.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications, which may be made without departing from the scope of the present disclosure as defined in the appended claims.

We claim:

1. A method comprising:
facilitating a selection of a region in a multimedia frame from among a plurality of multimedia frames;
performing an alignment of multimedia frames occurring periodically at a pre-defined interval in a capture order associated with the plurality of multimedia frames, wherein the alignment is performed based on the multimedia frame comprising the selected region;
computing region-match parameters for the aligned multimedia frames, wherein the region-match parameters are computed corresponding to the selected region in the multimedia frame;
selecting one or more multimedia frames from among the aligned multimedia frames based on the computed region-match parameters; and
identifying a multimedia frame from among the selected one or more multimedia frames and multimedia frames neighbouring the one or more selected multimedia frames based on the computed region-match parameters, wherein the multimedia frame is identified for configuring a loop sequence for an animated image.

2. The method as claimed in claim 1, wherein identifying the multimedia frame comprises:
performing for the selected one or more multimedia frames:
reducing the pre-defined interval by a fractional value;
determining a multimedia frame occurring at the reduced pre-defined interval from the selected multimedia frame in an ascending capture order and a descending capture order associated with the plurality of multimedia frames;
computing region-match parameters for the multimedia frames determined in the ascending capture order and the descending capture order;
comparing the region-match parameters for the multimedia frames determined in the ascending capture order and the descending capture order with the region-match parameter for the selected multimedia frame;
choosing a multimedia frame from among the selected multimedia frame and corresponding multimedia frames in the ascending capture order and the descending capture order with the region-match parameter corresponding to substantial match with the selected region in the multimedia frame; and
identifying a multimedia frame with the region-match parameter corresponding to substantial match with the selected region in the multimedia frame from among the chosen multimedia frames.

3. The method as claimed in claim 2, wherein for the chosen multimedia frames further performing repeatedly till the reduced pre-defined interval is greater than or equal to a pre-defined threshold interval:
reducing the reduced pre-defined interval by the fractional value;
determining a multimedia frame occurring at the reduced pre-defined interval from the chosen multimedia frame in an ascending capture order and a descending capture order associated with the plurality of multimedia frames;
computing region-match parameters for the multimedia frames determined in the ascending capture order and the descending capture order;
comparing the region-match parameters for the multimedia frames determined in the ascending capture order and the descending capture order with the region-match parameter for the chosen multimedia frame; and
choosing a multimedia frame from among the chosen multimedia frame and corresponding multimedia frames in the ascending capture order and the descending capture order with the region-match parameter corresponding to substantial match with the selected region in the multimedia frame.

4. The method as claimed in claim 1, further comprising generating motion map for indicating motion in one or more multimedia frames for facilitating selection of the region in the multimedia frame.

5. The method as claimed in claim 4, further comprising facilitating receiving a user input for performing one of an addition and deletion of region associated with the generated motion map for selecting the region in the multimedia frame.

6. The method as claimed in claim 1, further comprising providing one or more loop sequence options based on the selected region in the multimedia frame, wherein the one or more loop sequence options are provided based on a parameter value computed for one or more multimedia frames of the plurality of multimedia frames, wherein the parameter value for the one or more multimedia frames is computed corresponding to the selected region in the multimedia frame.

7. The method as claimed in claim 1, further comprising generating the animated image for the loop sequence configured based on the identified multimedia frame and the multimedia frame comprising the selected region.

8. The method as claimed in claim 7, further comprising displaying the animated image at a first temporal resolution and subsequently refining the display of the animated image to a second temporal resolution, wherein the second temporal resolution is greater than the first temporal resolution.

9. An apparatus comprising:
at least one processor; and
at least one memory comprising computer program code, the at least one memory and the computer program code configured to, with the at least one processor, cause the apparatus to at least perform:
facilitate a selection of a region in a multimedia frame from among a plurality of multimedia frames;
perform an alignment of multimedia frames occurring periodically at a pre-defined interval in a capture order associated with the plurality of multimedia frames, wherein the alignment is performed based on the multimedia frame comprising the selected region;
compute region-match parameters for the aligned multimedia frames, wherein the region-match parameters are computed corresponding to the selected region in the multimedia frame;
select one or more multimedia frames from among the aligned multimedia frames based on the computed region-match parameters; and
identify a multimedia frame from among the selected one or more multimedia frames and multimedia frames neighbouring the one or more selected multimedia frames based on the computed region-match parameters, wherein the multimedia frame is identified for configuring a loop sequence for an animated image.

10. The apparatus as claimed in claim 9, wherein for identifying the multimedia frame, the apparatus is further caused, at least in part, to:
perform for the selected one or more multimedia frames:
reduce the pre-defined interval by a fractional value;
determine a multimedia frame occurring at the reduced pre-defined interval from the selected multimedia frame in an ascending capture order and a descending capture order associated with the plurality of multimedia frames;
compute region-match parameters for the multimedia frames determined in the ascending capture order and the descending capture order;
compare the region-match parameters for the multimedia frames determined in the ascending capture order and the descending capture order with the region-match parameter for the selected multimedia frame;
choose a multimedia frame from among the selected multimedia frame and corresponding multimedia frames in the ascending capture order and the descending capture order with the region-match parameter corresponding to substantial match with the selected region in the multimedia frame; and
identify a multimedia frame with the region-match parameter corresponding to substantial match with the selected region in the multimedia frame from among the chosen multimedia frames.

11. The apparatus as claimed in claim 10, wherein the apparatus is further caused, at least in part, to perform repeatedly for the chosen multimedia frames till the reduced pre-defined interval is greater than or equal to a pre-defined threshold interval:
reduce the reduced pre-defined interval by the fractional value;
determine a multimedia frame occurring at the reduced pre-defined interval from the chosen multimedia frame in an ascending capture order and a descending capture order associated with the plurality of multimedia frames;
compute region-match parameters for the multimedia frames determined in the ascending capture order and the descending capture order;
compare the region-match parameters for the multimedia frames determined in the ascending capture order and the descending capture order with the region-match parameter for the chosen multimedia frame; and
choose a multimedia frame from among the chosen multimedia frame and corresponding multimedia frames in the ascending capture order and the descending capture order with the region-match parameter corresponding to substantial match with the selected region in the multimedia frame.

12. The apparatus as claimed in claim 9, wherein the apparatus is further caused, at least in part, to generate motion map for indicating motion in one or more multimedia frames for facilitating selection of the region in the multimedia frame.

13. The apparatus as claimed in claim 12, wherein the apparatus is further caused, at least in part, to facilitate receiving a user input for performing one of an addition and deletion of region associated with the generated motion map for selecting the region in the multimedia frame.

14. The apparatus as claimed in claim 13, wherein the apparatus is further caused, at least in part, to provide one or more loop sequence options based on the selected region in the multimedia frame, wherein the one or more loop sequence options are provided based on a parameter value computed for one or more multimedia frames of the plurality of multimedia frames, wherein the parameter value for the one or more multimedia frames is computed corresponding to the selected region in the multimedia frame.

15. The apparatus as claimed in claim 9, wherein the apparatus is further caused, at least in part, to generate the animated image for the loop sequence configured based on the identified multimedia frame and the multimedia frame comprising the selected region.

16. The apparatus as claimed in claim 15, wherein the apparatus is further caused, at least in part, to display the animated image at a first temporal resolution and subsequently refine the display of the animated image to a second temporal resolution, wherein the second temporal resolution is greater than the first temporal resolution.

17. A computer program product comprising at least one computer-readable storage medium, the computer-readable storage medium comprising a set of instructions, which, when executed by one or more processors, cause an apparatus to at least perform:
facilitate a selection of a region in a multimedia frame from among a plurality of multimedia frames;
perform an alignment of multimedia frames occurring periodically at a pre-defined interval in a capture order associated with the plurality of multimedia frames, wherein the alignment is performed based on the multimedia frame comprising the selected region;
compute region-match parameters for the aligned multimedia frames, wherein the region-match parameters are computed corresponding to the selected region in the multimedia frame;
select one or more multimedia frames from among the aligned multimedia frames based on the computed region-match parameters; and
identify a multimedia frame from among the selected one or more multimedia frames and multimedia frames neighbouring the one or more selected multimedia frames based on the computed region-match parameters, wherein the multimedia frame is identified for configuring a loop sequence for an animated image.

18. The computer program product as claimed in claim 17, wherein for identifying the multimedia frame, the apparatus is further caused, at least in part, to:
perform for the selected one or more multimedia frames:
reduce the pre-defined interval by a fractional value;
determine a multimedia frame occurring at the reduced pre-defined interval from the selected multimedia frame in an ascending capture order and a descending capture order associated with the plurality of multimedia frames;
compute region-match parameters for the multimedia frames determined in the ascending capture order and the descending capture order;
compare the region-match parameters for the multimedia frames determined in the ascending capture order and the descending capture order with the region-match parameter for the selected multimedia frame;
choose a multimedia frame from among the selected multimedia frame and corresponding multimedia frames in the ascending capture order and the descending capture order with the region-match parameter corresponding to substantial match with the selected region in the multimedia frame; and
identify a multimedia frame with the region-match parameter corresponding to substantial match with the selected region in the multimedia frame from among the chosen multimedia frames.

19. The computer program product as claimed in claim 18, wherein the apparatus is further caused, at least in part, to perform repeatedly for the chosen multimedia frames till the reduced pre-defined interval is greater than or equal to a pre-defined threshold interval:
reduce the reduced pre-defined interval by the fractional value;
determine a multimedia frame occurring at the reduced pre-defined interval from the chosen multimedia frame in an ascending capture order and a descending capture order associated with the plurality of multimedia frames;
compute region-match parameters for the multimedia frames determined in the ascending capture order and the descending capture order;
compare the region-match parameters for the multimedia frames determined in the ascending capture order and the descending capture order with the region-match parameter for the chosen multimedia frame; and
choose a multimedia frame from among the chosen multimedia frame and corresponding multimedia frames in the ascending capture order and the descending capture order with the region-match parameter corresponding to substantial match with the selected region in the multimedia frame.

20. The computer program product as claimed in claim 17, wherein the apparatus is further caused, at least in part, to generate the animated image for the loop sequence configured based on the identified multimedia frame and the multimedia frame comprising the selected region.
